(19) United States
(12) Patent Application Publication
(10) Pub. No.: US 2006/0215054 A1
(43) Pub. Date: Sep. 28, 2006

(54) Wide angle camera with prism array

(75) Inventors: Rongguang Liang, Penfield, NY (US); David Kessler, Rochester, NY (US); John N. Border, Walworth, NY (US); Joseph R. Bietry, Rochester, NY (US); Scott C. Cahall, Fairport, NY (US); Heidi L. Hall, Webster, NY (US); William T. Goosey JR., Fairport, NY (US)

Correspondence Address: Mark G. Bocchetti;Patent Legal Staff, Eastman Kodak Company, 343 State Street, Rochester, NY, 14650-2201, US

(73) Assignee: Eastman Kodak Company

(21) Appl. No.: 11/087,304

(22) Filed: Mar. 23, 2005

(51) Int. Cl. H04N 9/07

(52) U.S. Cl. 348/337

(57) ABSTRACT

An imaging apparatus (40) has an optical sensor (14) with sensing elements (18). Each sensing element (18) has an array of sensing components (28). Each sensing component (28) provides a signal corresponding to a pixel for forming an image as an array of pixels. A lens array (76) has a number of lens elements (66). Each lens element (66) directs light to a corresponding sensing element (18) in the optical sensor (14). A prism array (60) has a number of prism elements (62), each prism element (62) directing incident light from the image field toward a corresponding lens element (66) in the lens array (76).

### FIELD OF THE INVENTION

This invention generally relates to image capture devices and more particularly to a camera having an optical sensor comprising an array of sensing elements and using an array of prisms for redirecting incident light toward the optical sensor to provide a wide field of view.

### BACKGROUND OF THE INVENTION

The challenge of providing wide-angle image capture has conventionally been addressed using optical systems that require a relatively short focal length. These systems are characterized by bulky lens components, not easily packaged in compact form and not suitable for use in hand-held devices or other apparatus where small size is needed. The design of highly compact, wide-angle image capture optics proves to be challenging and typically requires some compromise in performance and a significant effort to minimize image aberrations.

To date, lenslet arrays have been employed within optical systems for concentrating light onto small-scale photodetector devices. Examples of typical uses and configurations of lenslet arrays include the following:
Commonly-assigned U.S. Pat. No. 6,137,535 (Meyers) discloses a compact digital camera using an array of custom-fabricated lenslets. In the embodiment described in U.S. Pat. No. 6,137,535 individual lenslets are fabricated in decentered form, to direct light from a different section of the field of view onto a planar photosensor. This type of design becomes highly complex, as each lenslet has a slightly different shape; moreover, as shown in U.S. Pat. No. 6,137,535, supporting light-guiding structures having varied angular inclinations are also needed.
European Application No. EP 1 079 613 (Tanida et al.) discloses a compound imaging apparatus employing a lenslet array that is compact and provides improved resolution over earlier designs.
Japanese Patent Application No. JP 10-107975 (Satoshi) discloses a compound imaging apparatus employing a lenslet array and a corresponding sensor array, both having a concave shape for obtaining improved resolution and brightness.
U.S. Patent Application Publication No. 2002/0075450 (Aratani et al.) discloses a compound eye imaging system optimized for obtaining images with improved depth detection.
In the apparatus of U.S. Patent Application Publication No. 2002/0075450, individual lenslets may be shaped differently to redirect light from the imaged object.
European Patent Application No. EP 0 821 532 (Ono) discloses use of a compound eye imaging system for stereoscopic imaging applications.
U.S. Patent Application Publication No. 2003/0111593 (Mates) discloses a compound eye imaging system having a lenslet array, wherein the shape of individual lenslet structures is adapted to collect light from an object.
U.S. Patent Application Publication No. 2003/0086013 (Aratani) discloses an alternate design for a camera apparatus using a compound-eye lenslet array.
U.S. Pat. No. 4,783,141 (Baba et al.) discloses a curved array of lenses for use in a variable magnification compound-eye imaging system.

As this patent literature shows, lenslet arrays are advantaged in providing a refractive component with a thin profile and relatively low cost, usable in a number of types of imaging apparatus, including those requiring a large field of view. Lenslet arrays can be scaled to accommodate a widened field of view, simply by adding one or more rows or columns of lenslets to an array. However, conventional lenslet array arrangements exhibit a number of problems, including reduced numerical aperture (large f/#) relative to conventional optical solutions and large, overlapping image fields.

Moreover, adapting lenslet arrays to the problem of directing light onto an array of sensor elements is a complex and difficult challenge, increasing the cost of lens array components and degrading image quality, requiring more complex image processing.

There is a recognized need for thin-profile imaging devices in a number of imaging markets, for devices such as cell phones, compact medical imaging devices, and other apparatus. While lenslet arrays provide some advantages such as compact sizing due to reduced working distance, the limitations of these devices with respect to numerical aperture and limited field of view constrain the use of these devices in hand-held imaging apparatus.

### SUMMARY OF THE INVENTION

It is an object of the present invention to provide an image capture device using an array of prism elements and providing improved field of view. With this object in mind, the present invention provides an imaging apparatus comprising:
(a) an optical sensor comprising a plurality of sensing elements, wherein each sensing element comprises an array of sensing components, wherein each sensing component provides an output signal for forming a pixel in an array of image pixels;
(b) a lens array comprising a plurality of lens elements, wherein each lens element directs light to a corresponding sensing element in the optical sensor; and
(c) a prism array comprising a plurality of prism elements, each prism element directing incident light from the image field toward a corresponding lens element in the lens array.

It is an advantage of the present invention that it can provide a wide field of view with increased light collection efficiency in a compact apparatus.

It is a further advantage of the present invention that it can provide increased numerical aperture over many flat-panel lenslet array designs.

It is a further advantage of the present invention that it is scalable and capable of providing improved distortion and reduced vignetting over conventional, single-stage optical designs.

It is yet a further advantage of the present invention that it is capable of providing improved resolution over conventional planar lens array configurations.

These and other objects, features, and advantages of the present invention will become apparent to those skilled in the art upon a reading of the following detailed description when taken in conjunction with the drawings wherein there is shown and described an illustrative embodiment of the invention.

### BRIEF DESCRIPTION OF THE DRAWINGS

While the specification concludes with claims particularly pointing out and distinctly claiming the subject matter of the present invention, it is believed that the invention will be better understood from the following description when taken in conjunction with the accompanying drawings, wherein:

FIG. 1 is a side view showing how an image is obtained using a conventional planar lens array;

FIG. 2 is a side view showing a curved arrangement of lenslets and the ideal placement of their corresponding sensors;

FIGS. 3A and 3B are side and perspective views of a portion of a prism array and associated lens elements in one embodiment of the present invention;

FIG. 4 is a magnified perspective view showing a portion of the prism array and its supporting lens elements;

FIGS. 5A and 5B are side views showing different profiles for a prism array in different embodiments;

FIG. 6A is a side view showing light redirection and focusing according to the present invention

FIG. 6B is a plot showing typical lateral color aberration;

FIG. 7 is a block diagram showing image capture and processing components of an imaging apparatus according to the present invention; and

FIG. 8 is a plan view showing the array arrangement of sensing elements on an optical sensor according to one embodiment.

### DETAILED DESCRIPTION OF THE INVENTION

The present description is directed in particular to elements forming part of, or cooperating more directly with, apparatus in accordance with the invention. It is to be understood that elements not specifically shown or described may take various forms well known to those skilled in the art.

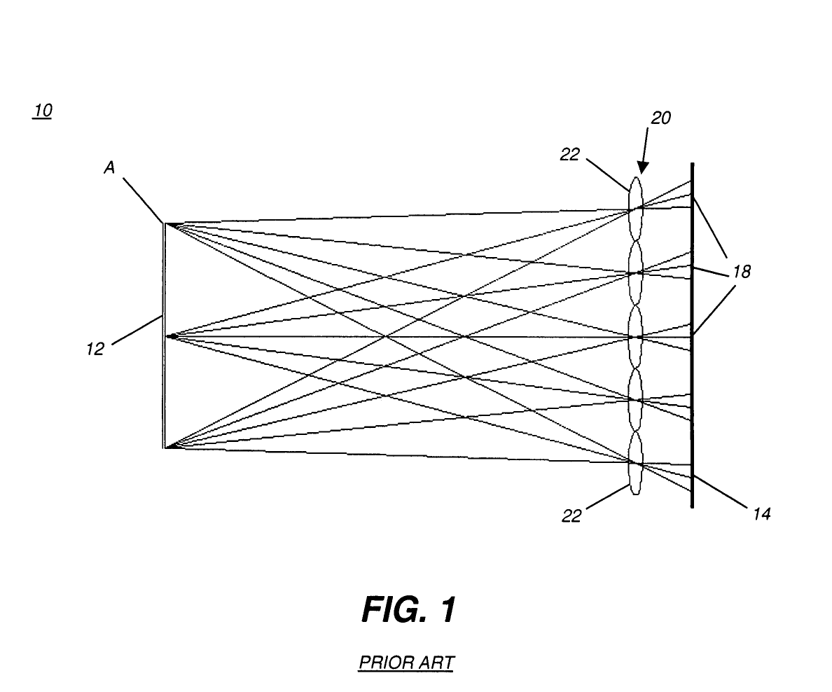

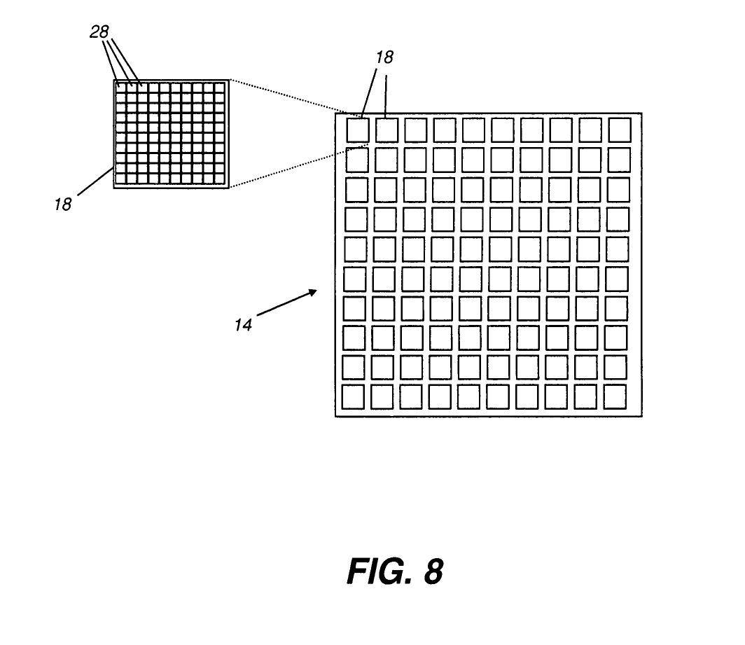

In conventional use, as shown in FIG. 1, an image capture apparatus 10 employs a flat, planar lenslet array 20 of lenses 22 for directing light from an object 12 to an optical sensor 14 comprising an array of sensing elements 18. As shown in FIG. 8 (not to scale but exaggerated for clarity), each sensing element 18 has, in turn, an array of sensing components 28 that provides the data for an array of image pixels. Each sensing component 28 provides an output signal for forming a pixel, using the conventional pixel-based image presentation scheme well known to those skilled in the imaging arts. In one embodiment, each sensing element 18 has a 100×100 array of sensing components 28, thus providing a 100×100 array of image pixel data from each sensing element 18. Optical sensor 14 then has a 10×10 array of sensing elements 18. With this arrangement, optical sensor 14 thus provides an image with a 1000×1000 pixel array of image data.

Optical sensor 14 may be any of a number of types of sensing devices, such as a charge-coupled device (CCD) or complementary metal oxide semiconductor (CMOS) sensor array, for example. In one embodiment, optical sensor 14 is monolithic, packaged on a single substrate as is shown in FIG. 8. Individual sensing elements 18 are discrete sensing areas on optical sensor 14, which may be separated from each other by unused sensing areas. However, optical sensor 14 could alternately be formed by arranging individual sensing elements 18, each on its own substrate, into an array. In one embodiment, each lens 22 of lenslet array 24 has a corresponding sensing element 18; however, the assignment of one sensing element 18 to multiple lenses 22 is also possible, as is the assignment of one lens 22 to multiple sensing elements 18.

One difficulty with the planar arrangement of lenslet array 20 and its corresponding optical sensor 14 in FIG. 1 relates to image quality inconsistencies across the field. Each lens 22 has a relatively large field, so that portions of images from different sensing elements 18 are superimposed. This means that light from the same point source is detected at multiple sensing elements 18. Referring to FIG. 1, for example, light from point A on object 12 is directed to each sensing element 18 in optical sensor 14.

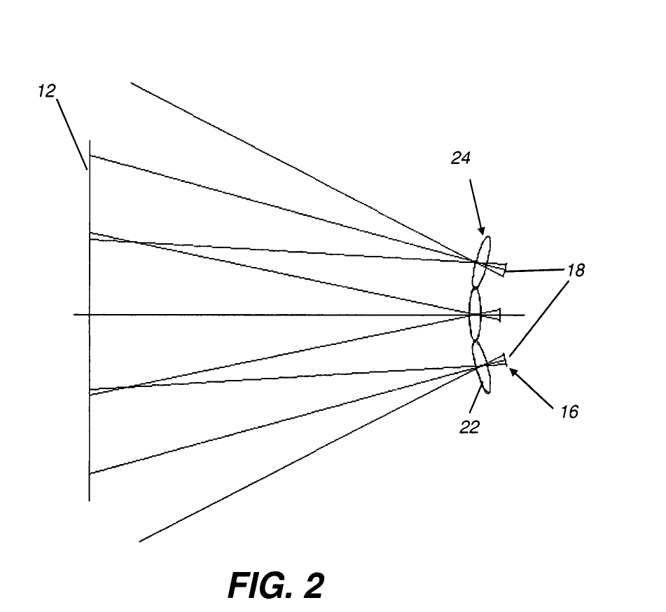

Referring to FIG. 2, there is shown a possible “compound eye” imaging arrangement that would alleviate some of the problems of the system shown in FIG. 1. Here, a curved lenslet array 24 has a number of lenses 22 for directing light to sensing elements 18 in a curved optical sensor 16. Unlike the planar arrangement of FIG. 1, the curved shape used for curved lenslet array 24 effectively separates the field of view of each lens 22, allowing each lens 22 to collect light from a different part of the field. In contrast to the planar arrangement of FIG. 1, each lens 22 images a smaller field, which allows higher resolution and overall image quality. At the same time, each lens 22 can also have a lower f/#, allowing increased light collection.

While the arrangement of FIG. 2 has advantages for imaging, however, there are disadvantages. In particular, optical sensor 16 must have some curvature; otherwise, benefits of the curvature of curved lenslet array 24 are lost. There are practical limitations that may make it difficult to configure optical sensor 16 in this way.

Prism arrays have had limited use in a few specialized imaging applications, such as in the scanning application disclosed in U.S. Pat. No. 6,057,965 (Angelo et al.), for example. However, prism arrays are not a conventional solution in image capture applications. The apparatus and method of the present invention adapt a prism array to direct light for image capture.

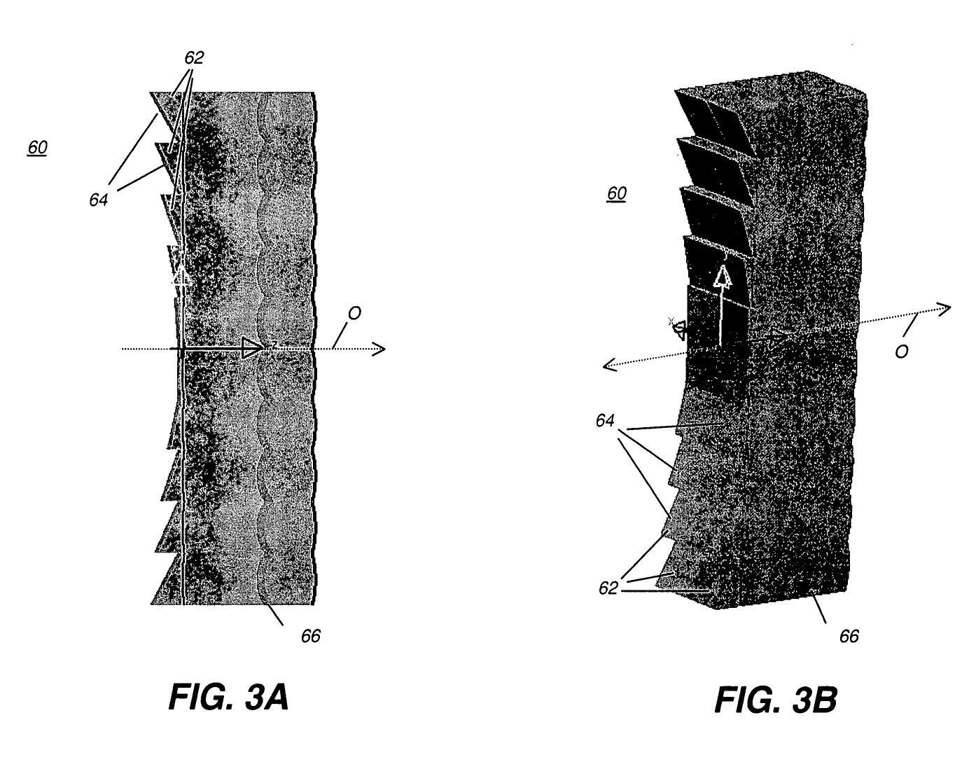

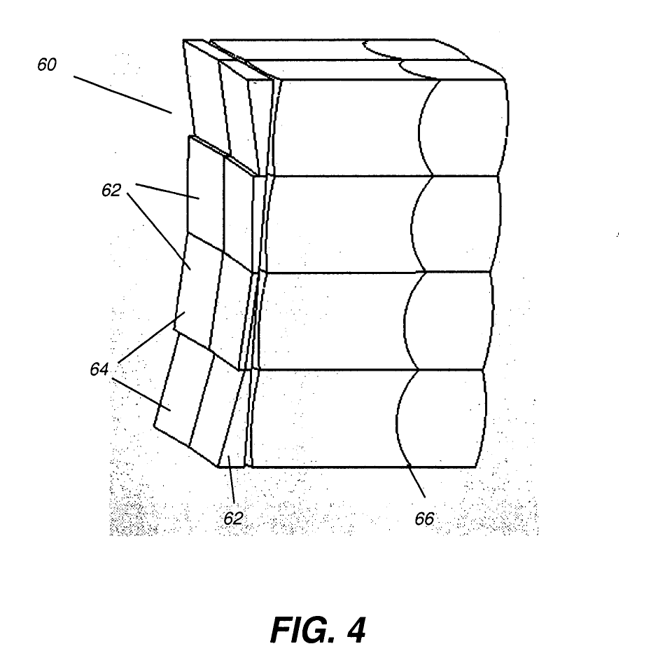

Referring to FIG. 3A, there is shown a side view of a prism array 60. Prism array 60 has an arrangement of prisms 62 with incident facets 64 slanted at variable angles, based on their relative distance from central axis O. FIGS. 3B and 4 show angled facets 64 from a perspective view. Facets 64 near central axis O are approximately angled at a normal to central axis O. Facets 64 are angled away from normal in an increasing manner as prisms 62 are located closer to the periphery of prism array 60. With this arrangement, each prism in prism array 60 directs incident light toward the optical axis of each lens element 66, as is shown subsequently. Each prism 62 is optically coupled to a corresponding lens element 66, as is also shown in the magnified view of FIG. 4. Each group (prism 62 together with lens element 66) collects light from a different part of the field, similar to possible “compound eye” imaging arrangement shown in FIG. 2. So the system allows larger light collection efficiency, higher resolution and overall image quality.

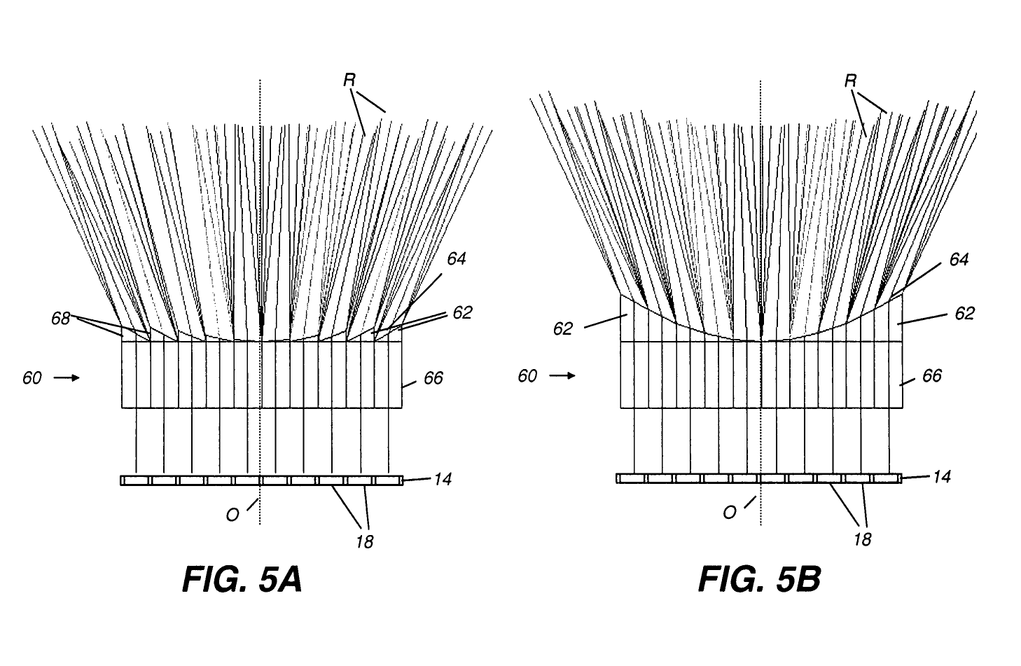

Referring to FIGS. 5A and 5B, two slightly different embodiments of prism array 60 are shown. Incident light rays R from the viewed object are redirected by prisms 62 to their corresponding lens elements 66. Lens elements 66 then direct the light to individual sensing elements 18 on optical sensor 14. As is shown in FIGS. 5A and 5B, each sensing element 18 is optically coupled to a corresponding lens element 66 and prism 62. As is shown by the angular spread of light rays R, this arrangement provides a wide field of view for image capture.

The shapes of prisms 62 differ between the embodiments of FIGS. 5A and 5B. In the embodiment of FIG. 5A, prisms 62 have distinct draft facets 68 that are generally normal to the surface of optical sensor 14, that is, parallel to central axis O. In the embodiment of FIG. 5B, however, there is a relatively smooth transition between angled facets 64 for adjacent prisms 62. This arrangement gives prism array 60 a generally concave curvature, unbroken by draft facets 68.

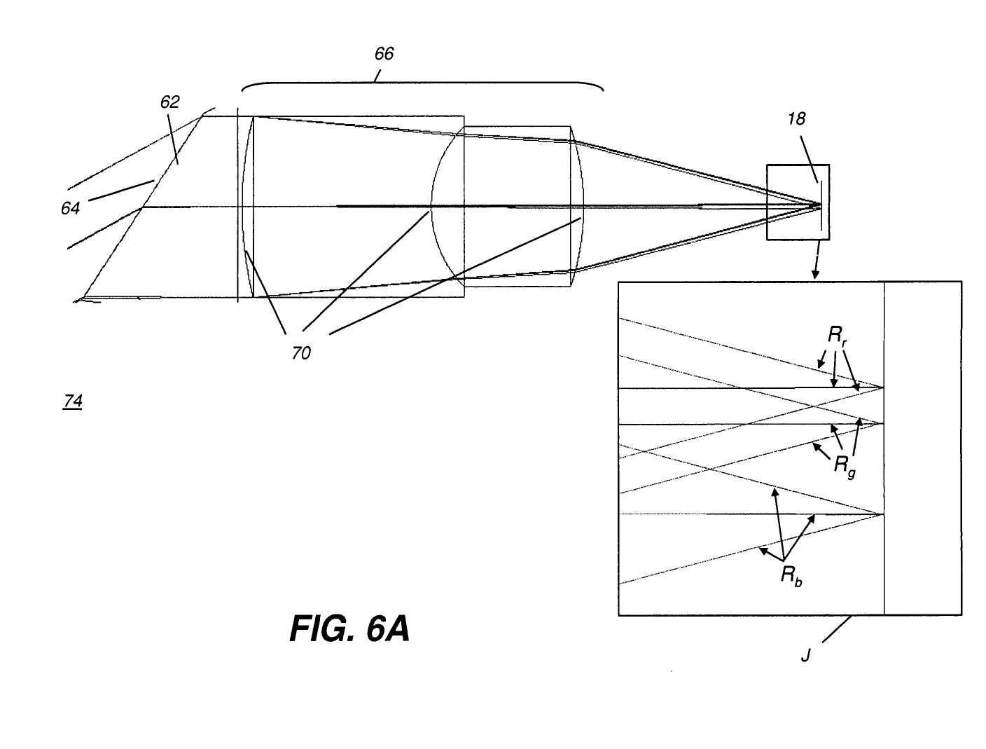

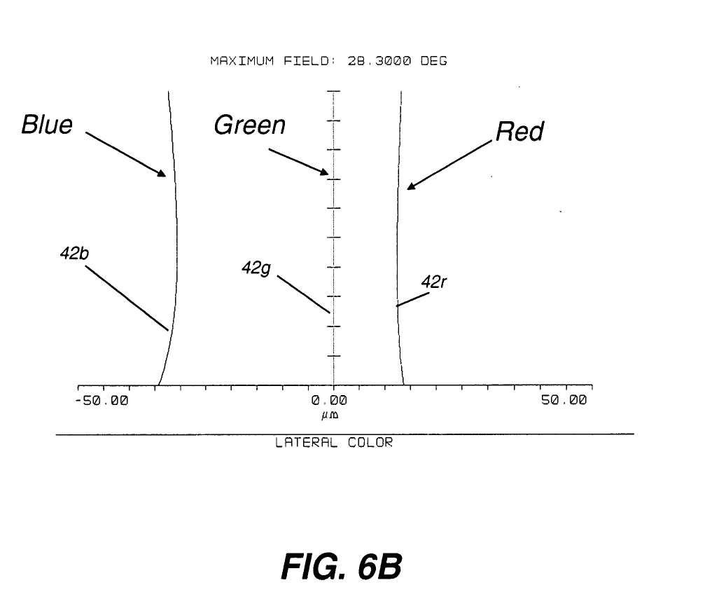

As is shown in the cross-section view of a light path 74 in FIG. 6A, lens element 66 may contain one or more lenses 70. Lenses 70 may be fabricated from one or more aligned lenslet arrays. Prism array 60 has a number of prisms 62 arranged horizontally and vertically, in a matrixed array fashion that corresponds to the overall arrangement scheme used for optical sensor 14. In one embodiment, a 10×10 arrangement of prisms 62 is used to provide an image to a 10×10 array of sensing elements 18, yielding a wide field of view.

Some amount of field overlap between adjacent sensing elements 18 is likely with the arrangement of FIGS. 3A through 6A. Image processing can be used to compensate for this effect, using algorithmic techniques familiar to those skilled in the image processing arts.

Correcting Lateral Color Aberration

As will be readily recognized by those skilled in the optical arts, prisms 62 refract light in a wavelength dependent manner. This causes a slight separation of color paths for each sensing element 18, as is shown in the magnified inset portion J of FIG. 6A. Red, green, and blue light, indicated by rays Rᵣ, R_{g}, and R_{b} in FIG. 6A, are directed by lens 66 to slightly different positions on sensing element 18, causing lateral color aberration. FIG. 6B shows how lateral color aberration is conventionally represented. Curves 42r (red), 42g (green), and 42b (blue) are shown separated from each other; curves 42r, 42g, and 42b would be precisely overlaid if there were no lateral color aberration.

As a further complication, lateral color aberration will vary for each sensing element 18, based on the relative angle of incident light on its corresponding prism 62. Correction for lateral color aberration can be computed for each sensing element 18 using methods disclosed in commonly-assigned U.S. Pat. No. 6,747,702 (Harrigan), incorporated herein by reference. U.S. Pat. No. 6,747,702, a quadrant method is used to calculate and correct for lateral color aberration over a field. The method of U.S. Pat. No. 6,747,702 assumes an axisymmetric lens, but could be readily extended to an asymmetric lens design.

System Description

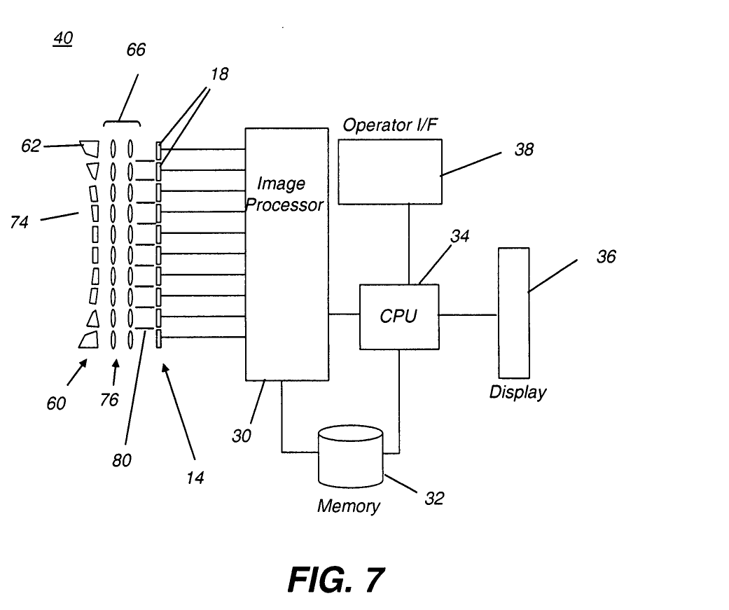

Referring to FIG. 7, there is shown, in block diagram form, a configuration of an imaging apparatus 40, such as a camera, using prism array 60, with a lens element array 76 containing a number of lens elements 66 arranged according to the present invention, as described above. Each lens element 66 directs light from its corresponding prism 62 to a sensing element 18 in optical sensor 14. To minimize crosstalk between channels, an array of baffles 80 is provided, with each baffle 80 positioned to block stray light from the light path between each lens element 66 and its corresponding sensing element 18. Sensing elements 18 provide signals that are converted into pixel image data by an image processor 30. Image processor 30 may store the pixel image data obtained in a memory 32 or other type of data buffer. A control logic processor 34 communicates with an operator interface 38, directs the operation of image processor 30, and typically displays a version of the captured image on a display 36, such as a CRT, an LCD, or organic light emitting diode (OLED) display, for example.

The method of the present invention provides an imaging system that can be scaled to allow a suitable number of light paths 74. Thus a 10×10, 12×12, or other arrangement of light paths 74 could be designed, suited to the desired geometry of optical sensor 14 and to the desired field of view. The apparatus of the present invention takes advantage of a reduced focal length for providing a compact arrangement of components.

The invention has been described in detail with particular reference to certain preferred embodiments thereof, but it will be understood that variations and modifications can be effected within the scope of the invention as described above, and as noted in the appended claims, by a person of ordinary skill in the art without departing from the scope of the invention. For example, the number and design of lens elements 66 in lens array 76 can be adjusted, depending on the field of view that is needed. Lenslet array 76 components may be fabricated from any of a number of types of transparent materials, including plastics such as polystyrene and including glass. Sensing elements 18 may be any suitable type of light sensor and may be provided with appropriate filters for color sensing or for polarization. Optical sensor 14 may have a number of possible arrangements, including one in which only a portion or portions of a surface having multiple sensing elements 18 is actively used.

The apparatus of the present invention is capable of providing improved imaging performance over image capture apparatus using conventional single-lens designs or flat panel lenslet arrays. Distortion is greatly reduced, color correction improved, and vignetting effects minimized. The present invention provides an apparatus that provides improved numerical aperture for gathering light over conventional flat panel lenslet cameras and can be adapted to high-resolution imaging requirements. Image processing algorithms can be applied for correction of lateral color aberration.

Thus, what is provided is an apparatus and method for improved wide-angle image capture over conventional designs using an optical sensor to provide a wide field of view.

### Parts List

10 image capture apparatus
12 object
14 optical sensor
16 optical sensor
18 sensing element
20 lenslet array
22 lens
24 lenslet array
28 sensing component
30 image processor
32 memory
34 control logic processor
36 display
38 operator interface
40 imaging apparatus
42r curve, red
42g curve, green
42b curve, blue
60 prism array
62 prism
64 facet
66 lens element
68 draft facet
70 lens
74 light path
76 lens element array
80 baffle

1. An imaging apparatus comprising:
(a) an optical sensor comprising a plurality of sensing elements, wherein each sensing element comprises an array of sensing components, wherein each sensing component provides an output signal for forming a pixel in an array of image pixels;
(b) a lens array comprising a plurality of lens elements, wherein each lens element directs light to a corresponding sensing element in the optical sensor; and
(c) a prism array comprising a plurality of prism elements, each prism element directing incident light from the image field toward a corresponding lens element in the lens array.

2. An imaging apparatus according to claim 1 wherein a light blocking baffle is provided between at least one pair of adjacent sensing elements.

3. An imaging apparatus according to claim 1 wherein at least one sensing element in the optical sensor is a CMOS device.

4. An imaging apparatus according to claim 1 wherein at least one sensing element in the optical sensor is a charge-coupled device.

5. An imaging apparatus according to claim 1 further comprising:
(d) an image processor for forming pixel image data according to the output signals from the array of sensing elements of the optical sensor; and
(e) a memory for storing the pixel image data obtained from the image processor.

6. An imaging apparatus according to claim 4 wherein the image processor corrects for lateral color aberration.

7. An imaging apparatus according to claim 4 wherein the image processor corrects for field overlap between adjacent sensing elements.

8. An imaging apparatus according to claim 1 wherein a plurality of prism elements comprise a draft facet disposed substantially at a normal with respect to the surface of the optical sensor.

9. An imaging apparatus according to claim 5 further comprising a display for forming an image showing the pixel data obtained.

10. An imaging apparatus according to claim 1 wherein the optical sensor is a monolithic device.

11. An imaging apparatus comprising:
(a) an optical sensor comprising a plurality of sensing elements, wherein each sensing element comprises an array of sensing components, wherein each sensing component provides an output signal for forming a pixel in an array of image pixels;
(b) a lens array comprising a plurality of lens elements, wherein each lens element directs light to a corresponding sensing element in the optical sensor;
(c) a prism array comprising a plurality of prism elements, each prism element directing incident light from the image field toward a corresponding lens element in the lens array; and
(d) a light blocking baffle disposed between at least one pair of adjacent sensing elements.

12. An imaging apparatus according to claim 11 wherein at least one sensing element in the optical sensor is a CMOS device.

13. An imaging apparatus according to claim 11 wherein at least one sensing element in the optical sensor is a charge-coupled device.

14. A method for capturing an image, comprising:
(a) providing an optical sensor comprising a plurality of sensing elements, wherein each sensing element further comprises an array of sensing components, wherein each sensing component provides a signal corresponding to a pixel for forming an image as an array of pixels;
(b) disposing a lens element to be optically coupled to each sensing element in the optical sensor, forming an array of lens elements thereby; and
(c) optically coupling a prism element to each lens element for directing incident light from the image field toward the lens element in the lens array, forming a prism array thereby.

15. The method according to claim 14 further comprising
(a) obtaining the signal from each of a plurality of sensing components; and
(b) processing the signal to form pixel image data.

16. The method according to claim 15 wherein the step of processing the signal further comprises compensating for lateral color aberration in the signal from each of the plurality of sensing components.
